(19) United States
(12) Patent Application Publication
(10) Pub. No.: US 2002/0152101 A1
(43) Pub. Date: Oct. 17, 2002

(54) Travel expense management module for an intranet portal

(76) Inventors: Robert J. Lawson, Cincinnati, OH (US); Lance C. Shumaker, Loveland, OH (US); Deborah A. Sollenberger, Mason, OH (US)

Correspondence Address: MCNEES WALLACE & NURICK LLC, 100 PINE STREET, P.O. BOX 1166, HARRISBURG, PA, 17108-5300, US

(21) Appl. No.: 09/833,434

(22) Filed: Apr. 12, 2001

(51) Int. Cl. G06F 17/60

(52) U.S. Cl. 705/6

(57) ABSTRACT

A travel expense management application is provided to assist users in submitting travel requests for approval and to assist decision-makers on whether or not to approve the travel requests. A user can complete a travel request online and submit the request to a decision-maker for approval. The user can also view all of the travel requests submitted by the user and check their current status. The decision-maker can access a list of pending travel requests and approve or reject each of the travel requests. The decision-maker can also review details on a specific travel request and a travel history for a particular user. The travel expense management application also has other tools and utilities that can reduce travel expenses. The travel expense management application has tools that assist in the scheduling of conference calls and tools that can facilitate and online collaboration or meeting over an Intranet or Internet.

### BACKGROUND OF THE INVENTION

The present invention relates generally to an application for travel expense management. More specifically, the present invention relates to an application for use on an Intranet that can manage the travel needs and expenses of employees and provide the employee with other alternatives to traveling.

In many companies or organizations, the employees of the company or organization may be required to travel to different locations in the course of their employment. The traveling of employees on business has many consequences for the company or organization. One consequence of employee travel is that the company or organization may have to incur large travel costs, such as transportation, food and lodging costs, while the employee is traveling on business. Another consequence of employee travel is that the employee is frequently not as productive when traveling on business as when the employee is working in the office.

Employee trip requests usually have to be approved before the employee can travel on business. The approval process begins with the employee submitting a request to a supervisor. The request can be in the form of a paper request or an e-mail request. The supervisor can then review the request and then approve or disapprove of the request, typically by a return paper or e-mail. The request and approval process can also become more difficult if either the request or the approval are lost or discarded. Once approved, the employee can then obtain the funds from the appropriate budget. The supervisor typically handles each request individually and can have a difficult time in knowing the travel history of the employee or the employee's group and the cumulative travel cost to date, without performing extensive research and individual effort. Finance professionals are usually responsible for monitoring the cumulative travel cost of an entire operating component or division with finance management tools. In addition, when making a travel request, the employee may not be aware of other less expensive options to traveling such as conference calls, video conferencing or online collaboration. Furthermore, the supervisor may not be aware of the possible use of these less expensive options when making a decision to approve a trip. Even if the employee or supervisor is aware of the less expensive options to traveling, the less expensive options still may not be used because the options may be difficult to access and/or use.

One technique for minimizing travel costs is described in U.S. Pat. No. 5,832,453 to O'Brien, hereafter referred to as O'Brien. In O'Brien, an objective function that accounts for travel information such as origin, destination, cost and carrier or provider is used to minimize travel costs. The objective function also factors in a number of constraints and restrictions. Some examples of constraints and restrictions include minimum and/or maximum spending thresholds for a particular carrier or provider. The objective function then determines the carrier or provider that should be used for a particular trip. While O'Brien can be effective in lowering travel costs for an organization, the technique in O'Brien does have some drawbacks. The technique in O'Brien does not offer an opportunity for a manager or supervisor to reject a trip request nor does it provide any alternatives to traveling by the employee.

Therefore what is needed is an application with all the tools required for submitting travel requests, approving travel requests, suggesting alternatives to traveling, and monitoring trip locations and cost that is accessible from a single location.

### BRIEF SUMMARY OF THE INVENTION

One embodiment of the present invention is directed to a system for managing the travel expenses of an organization. The system includes a server computer having a processor and a storage device and a client computer connected to the server computer over the network. The system also includes an application for managing travel expenses stored in the storage device of the server computer, or alternatively, the application is stored on the client computer. The application is accessible by a user on the client computer and can be executed by either the client computer or the server computer. The application has many features including options for submitting a travel request for a trip by the user, for evaluating a travel request by a supervisor of the user, for scheduling a conference call, for collaborating online, and for submitting an expense report.

Another embodiment of the present invention is directed to a computer program product embodied on a computer readable medium and executable by a computer for managing the travel expenses of an organization. The computer program product includes an option for submitting a travel request for a trip by a user and an option for evaluating a travel request by a supervisor of a user. The computer program product further includes an option for scheduling a conference call, an option for collaborating online and provides a user with a list of travel requests submitted by a user.

One advantage of the present invention is that an employee can manage his travel needs in a single location and access utilities that can be used as an alternative to traveling.

Another advantage of the present invention is that supervisors can review travel histories and costs before making a decision on an employee's travel request.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

The present invention is described in greater detail below with reference to the following drawings

FIG. 1 illustrates an example starting window or page for the travel expense management application;

FIGS. 2-4 illustrate example windows or pages for submitting a travel request with the travel expense management application;

FIG. 5 illustrates a user's travel summary chart with travel requests;

FIG. 6 illustrates an example window or page for scheduling a conference call with the travel expense management application; and

FIG. 7 illustrates an example window or page for the online collaboration tool of the travel expense management application.

FIG. 8 illustrates a supervisor's list of pending travel requests.

Whenever possible, the same reference numbers will be used throughout the figures to refer to the same parts.

### DETAILED DESCRIPTION OF THE INVENTION

The present invention is directed to an application for a computer network that is used for managing employee travel expenses, including submitting and approving travel requests, providing and coordinating alternatives to travel such as conference calls and online meetings, and monitoring trip locations and costs. The computer network is preferably an Intranet, however the application can also be used with any other type of network, for example, the Internet, a local area network (LAN), a wide area network (WAN) or Extranet. The computer network preferably has a central or server computer that is used to store the application and other files, web pages, databases, applications, etc. that can be used by the application. The computer network also preferably has one or more remote or client computers that can access the application stored on the server computer. In addition, the client computers can also be used to store other files, web pages, databases, applications, etc. that can be used by the application. The client computers and server computer can be any type of general purpose computer having memory devices (e.g. RAM, ROM, hard disk, CD-ROM, etc.), processing units (e.g. CPU, ALU, etc.) and input/output devices (e.g. monitor, keyboard, mouse, printer, etc.).

In an another embodiment of the present invention, each of the client or remote computers are again linked together through an Intranet, however instead of accessing the application on the server computer, the client computers have loaded into their memory a complete copy of the application. The application is preferably a software application that is executed from the memory device of the client computer. The application can be loaded into the memory device of the client computer from a portable medium such as a CD-ROM, DVD-ROM, floppy disk, etc., that is inserted into the client computer. Alternatively, the application can be transferred or loaded directly into the memory device of the client computer through an electronic connection with another computer that has a stored copy of the application. In other words, the application can be downloaded to a client computer from another computer over the network. Finally, the application may be implemented as hardware and incorporated as part of either client computers or the server computer.

As discussed above, the preferred embodiment of the computer network is an Intranet. To access the Intranet, the users of the Intranet can be provided with an Intranet portal to assist users in navigating and using the Intranet. A preferred embodiment of the Intranet portal is a portal that is constructed using modules or components. The modules are small pieces of functionality or applications preferably implemented with Java Server Page (JSP) or Servlet application programming interface (API) technology to supply or provide access to data, applications, information and processes to the user over the Intranet. The application of the present invention is preferably implemented as a module for the preferred Intranet portal. However, it is to be understood that the application of the present invention can be configured and adapted for any system or environment and can also be used as a “stand-alone” application on the computer network.

To use the network-based application of the present invention, the user first accesses a starting page or window 100 for the application. From the starting page 100 the user can access several different options relating to travel, meeting or event management, which options will be discussed in greater detail below. In addition, if the user has a network identification (ID) or e-mail identification, the email or network ID of the user is typically automatically entered by the application into field 102 from the user's profile. If the e-mail ID field is blank, the user can manually enter his e-mail ID into field 102. Travel or trip information associated with the user's e-mail ID entered into field 102 is displayed in a travel summary chart 104. The travel summary chart 104 includes information on requested and approved trips. The travel summary chart 104 provides the event ID 106 for the trip, a description 108 of the trip, a start or departure date 110 for the trip and the traveler 112 taking the trip, which is usually the user.

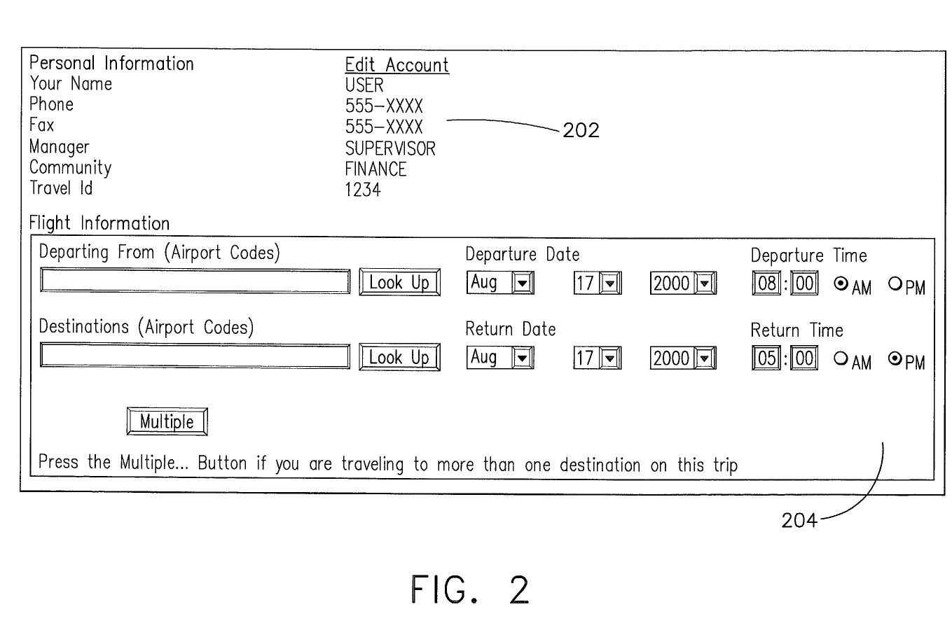

The user can also submit a travel request, create a conference call, submit an online expense report, delegate approval authority (if applicable), and access the meeting center from the starting page 100. To submit a travel request the user selects the fill out travel request option 114. By selecting the fill out travel request option 114, the user is provided with an online travel request form to complete. The online travel request form can be presented to the user in a separate window or windows or the user can be linked to a web page or pages that has the on-line travel request form. FIGS. 2-4 illustrate an online travel request form broken down into three windows. It is to be understood that the entire online travel request form can also be presented to the user in a single window or web page.

The online travel request form has a personal information section 202 and a flight information section 204 shown in FIG. 2. In the personal information section 202, the user can provide personal information. The personal information provided by the user can include the user's name, telephone number, fax number, manager and operational group or community. This information is preferably entered by the application from the user's profile. If the information is not correct, the user has the option of correcting the information. In addition, when the user requests the online travel request form, the travel request is assigned a travel ID which is included in the personal information section 202. In the flight information section 204, the user can provide the information that relates to the desired flight of the user. The flight information can include the departure airport, including airport code, the departure date and the departure time. The flight information can also include the destination airport, including airport code, the return date and the return time. If the user does not know an airport code for the departure airport or the destination airport, the user can enter the corresponding city and select an option (e.g. the “Look Up” button on FIG. 2) that presents the user with the names and airport codes of nearby airports from which the user can select. In addition, if the user's travel plans include more than one destination, the user can select an option (e.g. the “Multiple” button on FIG. 2) to enter in additional destinations for different legs of the trip. The user can then enter a predetermined additional number of destinations for the trip.

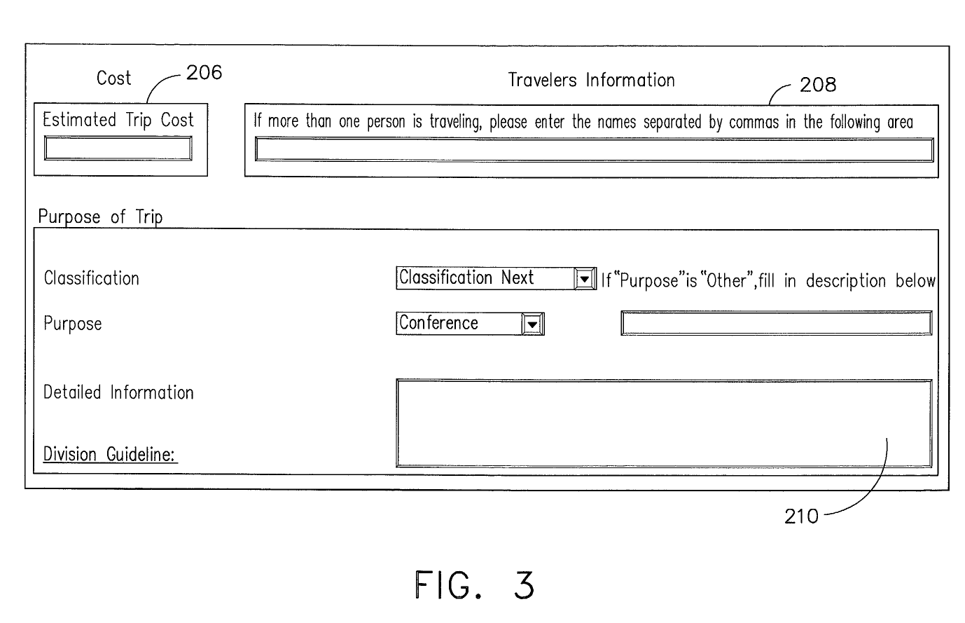

The online travel request form also has a cost section 206, a travelers information section 208 and a trip purpose section 210 shown in FIG. 3. In the cost section 206, the user enters the total estimated cost for the trip. The total estimated cost of the trip can include the cost of the airfare, car rental, hotel rooms and any other known cost and can include estimated costs for food and other unknown costs. If there is more than one traveler, the user enters the names of the additional travelers in the traveler information section 208. The user may also enter the total number of travelers in the traveler information section 208. In the trip purpose section 210, the user enters the reasons for the trip. The user enters a classification of the trip either by selecting a classification from a pull-down menu of predetermined choices or by manually entering a classification. The user also has to enter a purpose for the trip either by selecting a purpose from a pull-down menu of predetermined choices or by manually entering a purpose for the trip. The user can then enter a more detailed description for the purpose of the trip. Finally, the user can access division guidelines to obtain information on what the operational group's opinions are on certain matters.

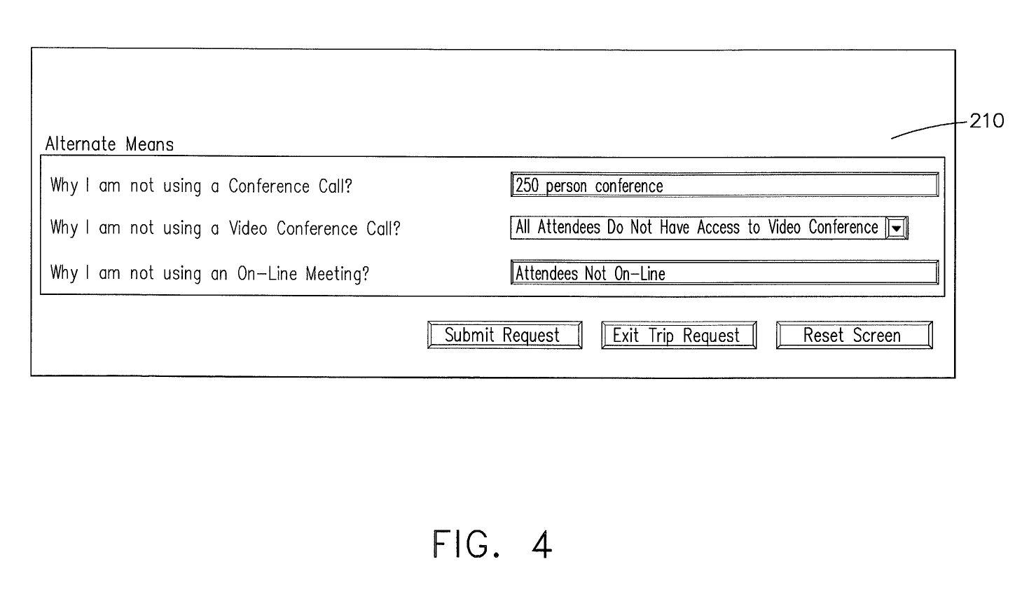

Finally, the online travel request form has an alternatives section 212 shown in FIG. 4. In the alternatives section 212, the user provides the reasons why alternatives to travel were not used. The user usually has to provide reasons why a conference call was not used, why a video conference was not used and why an online collaboration was not used. The can select reasons from a pull-down menu of predetermined reasons or the user can manually type in the reason. One reason for why a conference call was not used was that the user is attending a conference with a large number of attendees. Reasons why video conferencing and online collaboration are not used can include that the other party does not have the appropriate equipment or software to have a video conference or online collaboration.

Once the user has entered all the information into the online travel request form the user can submit the form to a supervisor for approval, exit the online travel request form and lose any entered information, or clear the online travel request form and reenter information into the online travel request form. In one embodiment of the present invention, the user can be prevented from submitting a request to a supervisor for approval until certain required information has been entered. The determination of what information is required is based on the criteria used by the supervisors in making their decisions and can include all the fields in the online travel request form. When the user submits the completed online travel request form, an e-mail is sent to the user with the details of the trip request entered by the user in the online trip request form and an e-mail is sent to the user's supervisor to notify the supervisor that a trip request has been submitted. The supervisor's responsibilities when a travel request is received are described in greater detail below.

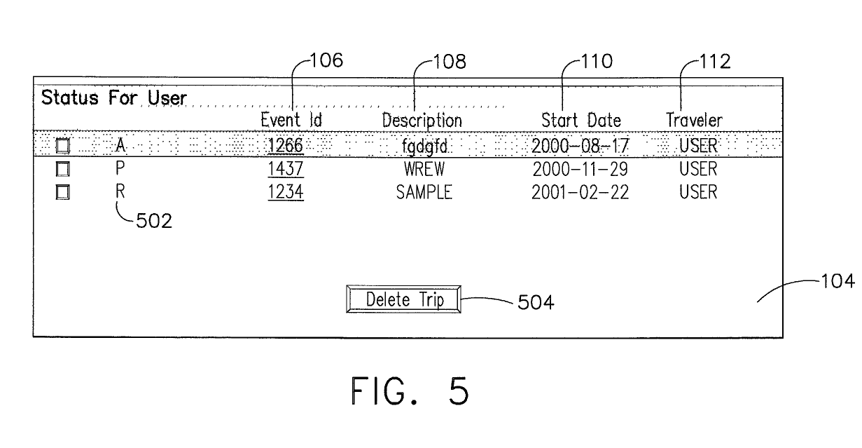

After the user submits a travel request for approval, the user's travel summary chart 104 is updated to include the requested trip. The requested trip is classified as pending until the supervisor approves or rejects the trip request. FIG. 5 illustrates a travel summary chart 104 with approved, rejected and pending trip requests. A user can select the event ID 106 for a particular trip request and be provided with the details of the trip that were entered into the online travel request form. By selecting a particular event ID the user is preferably linked or connected to a web page or window that has the travel details. In addition, the travel summary chart 104 includes an indicator 502 indicating the status of the travel request next to the event ID 106. The indicator 502 can be any type of symbol or marking that can be associated with a status of the travel request. For example, in FIG. 5 the indicators 502 used are “A” for approved, “R” for rejected and “P” for pending. In another embodiment of the present invention, the indicators 502 can be a green-filled circle for approved, a yellow filled circle for pending and a red-filled circle for rejected. However, it is to be understood that any indicators 502 that can be understood by the users may be used. The user can also remove trips that have not been completed, i.e. pending requests, rejected requests and approved request that have not been taken, from the travel summary chart 104. The user selects the trips to be removed from the travel summary chart 104 and then selects the delete trip option 504 from the travel summary chart 104.

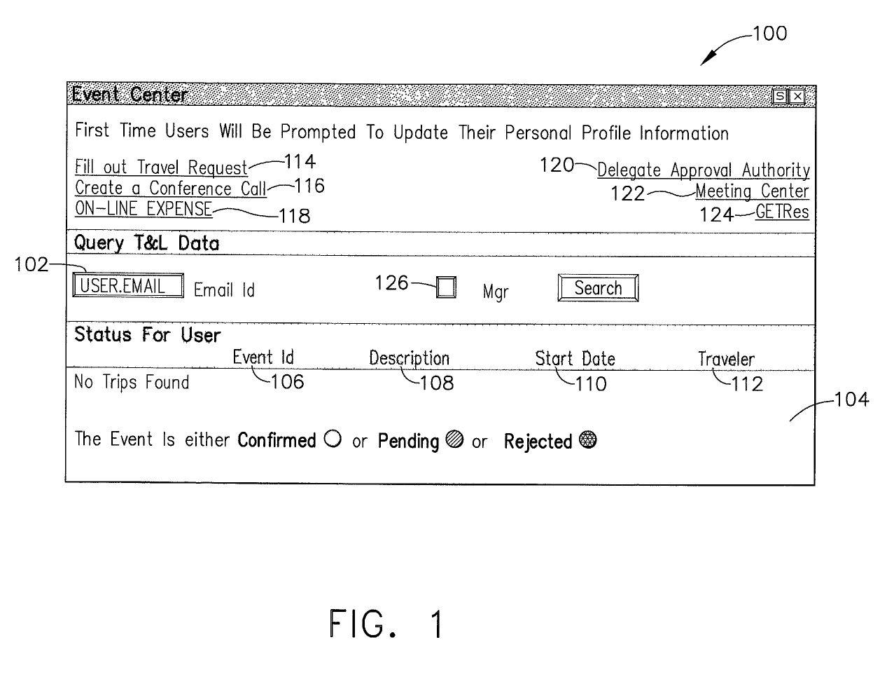

Referring back to FIG. 1, to create a conference call the user selects create a conference call option 116. By selecting the create a conference call option 116, the user is provided with assistance in coordinating and scheduling a conference call. Before a user can schedule a conference call, the user has to be setup for conference calls. The user conference call setup information is stored in the user's profile and is retrieved when the user selects the create a conference call option 116. If any of the conference call setup information is missing, the user requested to supply the missing information into the user's profile. The conference call setup information includes a 1-800-Number, a long distance number, a Dial Comm number, a chairperson access code, which is usually for the user, and a participant code for the other people on the conference call. In addition, the user is presented with the option to request conference call setup information, if the user does not have the necessary conference call setup information.

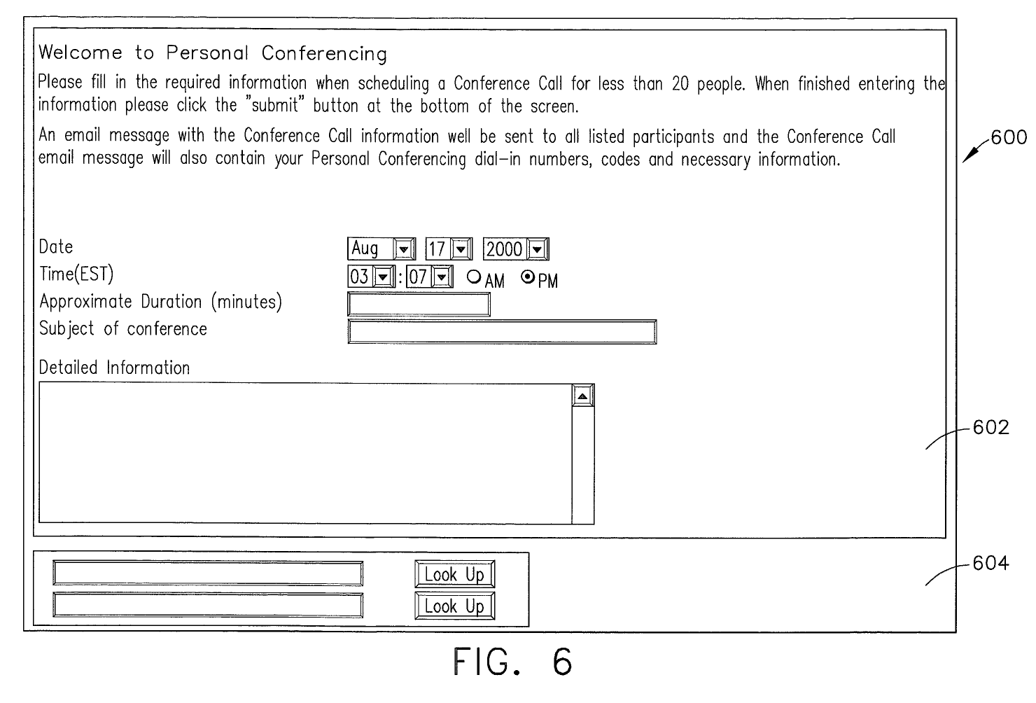

Once all of the user's conference call setup information has been entered and retrieved, the user is provided with a conference call scheduling form. The conference call scheduling form can be presented to the user in a separate window or windows or the user can be linked to a web page or pages that has the conference call scheduling form. FIG. 6 illustrates a conference call scheduling form 600 that can be in a web page or a window. To schedule a conference call, the user has to enter information on the conference call in the call information section 602. The conference call information that has to be entered includes the date and time of the conference call, the estimated duration of the conference call, the subject of the conference call and any additional details or information that relates to the conference call. Next, the user has to list the people who are to participate in the conference call in participant section 604. The list of people to participate in the conference call are entered by entering the e-mail address of each of the participants. If the user does not know an e-mail address for a participant, the user can enter the last name of the participant and select an option (e.g. the “Look Up” button on FIG. 6) that presents the user with the names and e-mail addresses of each person with the last name entered by the user. Finally, once the user has entered all the information into conference call scheduling form 600, the user then transmits the conference call information, including necessary setup information, by e-mail to all the listed participants of the conference call.

To complete and submit an expense report the user selects online expense option 118. By selecting the online expense option 118, the user is linked or connected to an organizational online expense reporting system for the user to submit and complete and expense report. In another embodiment of the present invention, when the user selects the online expense report option, the user is provided with a form and assistance in completing an expense report by the application. Furthermore, by selecting GETRes option 124, the user is linked or connected to an organizational travel system. The organizational travel system can provide the user information and assistance on a variety of different travel related issues and questions.

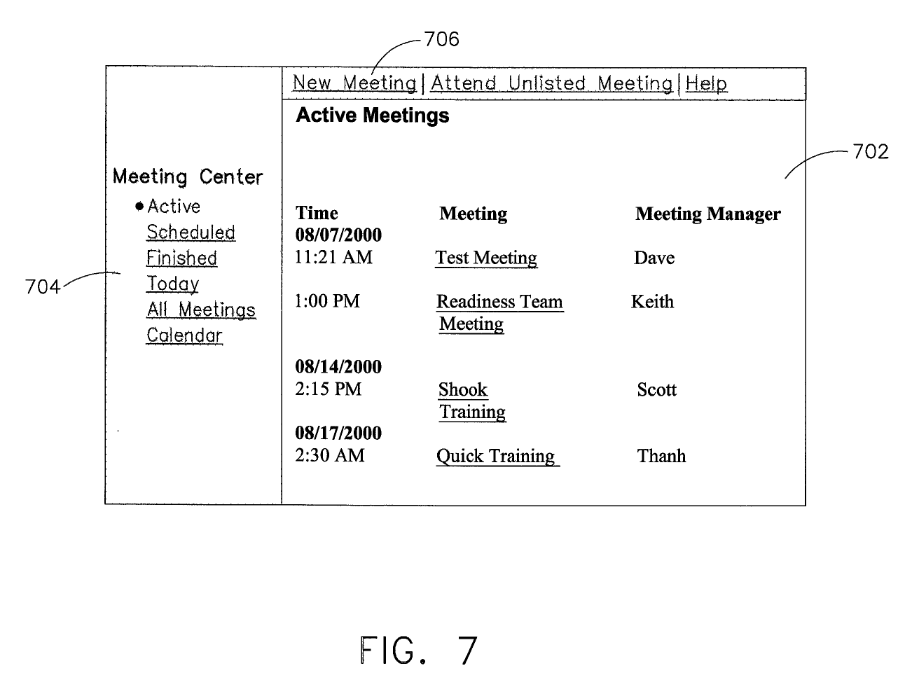

To initiate or participate in an online collaboration or meeting the user selects meeting center option 122. By selecting meeting center option 122, the user is provided with a utility or tool useful in facilitating online collaborations or meetings. One example, of a tool that can be used for online collaboration is Lotus Sametime, however, any similar online collaboration tool can be used. The online collaboration tool can be presented to the user in a separate window or windows or the user can be linked to a web page or pages that has the online collaboration tool. FIG. 7 illustrates the initial starting point of the online collaboration tool. The initial starting point has a display 702 that can be used to display a list of meetings. A list of meetings typically includes information on the date and time of the meeting, the title of the meeting and the manager of the meeting. In addition, the user can join a particular meeting by selecting the title or topic of the meeting, which results in the user being presented with a window or web page that permits the user to participate in the particular meeting. To change the list of meetings displayed in display 702, the user can select a new meeting list from the list of meeting categories 704. The categories of meetings in meeting categories 704 can include active meetings, scheduled meetings, finished meetings, meetings on today's date, all meetings and a calendar showing meetings by date. The user can also schedule meetings by selecting the new meeting option 706. New meeting option 706 connects the user to a window or web page that assists the used in scheduling a new online meeting or collaboration.

If the user is a manager or supervisor, the user selects box 126 to indicate the user's supervisory authority, which is confirmed by the application. Once the user is acknowledged as a supervisor, several additional options are available to the user. One option available to the supervisor is that the supervisor can enter in an e-mail ID for an employee and then retrieve the employee's travel summary chart 104 for review. In another embodiment of the present invention, users without supervisory authority can retrieve the travel summary chart 104 for other employees by entering their e-mail ID.

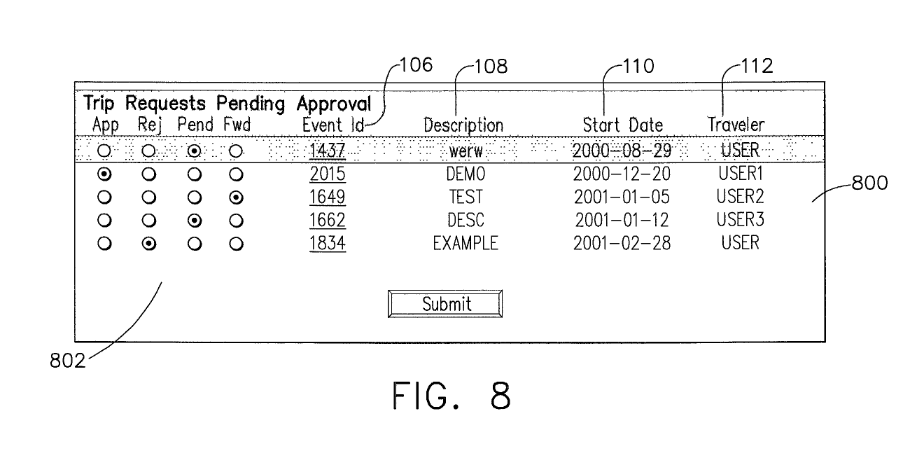

One of the supervisor user's main responsibilities is deciding on travel requests submitted by employees. The supervisor user can access a list of the pending requests on a separate window or web page from the starting page 100 or in another embodiment, the list of pending requests is included on the starting page 100. FIG. 8 illustrates a list of pending requests 800 for a supervisor. The list of pending requests 800 has the same information as the travel summary chart 104, i.e. the event ID 106, description 108, start date 110 and traveler 112. The supervisor can also access additional information about the trip request by selecting a link associated with the event ID 106, in a manner similar to that described above. In addition, the list of pending requests 800 has status determination section 802, for the supervisor to enter his decision on the status of the travel request. The supervisor can also enter comments and reasons for his decision on the trip request, that are included as part of the travel details. The supervisor may include reasons why a trip was approved or rejected and possibly include suggestions on how to correct defects in the request.

The status determination section 802 permits the supervisor to approve a trip request, reject a trip request, forward a trip request to another supervisor or manager and leave the trip request as pending. When a trip request is received from an employee, the trip request is assigned a status of pending and maintains that status until changed by a supervisor. In one embodiment of the present invention, the supervisor can change the status of the trip request by selecting an appropriate check box. However, other techniques for assigning a status can be used such as selecting the status from a pull-down menu or any other similar technique. After the supervisor has changed the status of the trip requests, the supervisor can notify the user of his decisions by selecting a submit button. The selection of the submit button changes the status of the trip requests in the employee's travel summary chart 104.

In addition, if the supervisor does not have the time to respond to the travel or trip requests in the list of pending requests, the supervisor can delegate approval authority to another person. To delegate authority, the supervisor selects the delegate approval authority option 120 from the starting page. The supervisor is the presented a window or connected to a web page with a form or tool that assists the supervisor is delegating approval authority. The supervisor has several options when using delegating approval authority. The user can assign the recipient of approval authority by entering the recipient's e-mail ID or other similar technique. The supervisor can also limit the time frame for the approval authority by entering a start date and an end date. In addition, the supervisor can also set parameters that limit the types of trips the recipient is able to approve. For example, a recipient may limited to approving trips with estimated costs less than a predetermined dollar amount or the recipient may limited to approving trips to certain locations or for certain employees. After the supervisor has delegated approval authority, the recipient is able to act on trip requests in a manner similar to that described above for the supervisor.

In another embodiment of the present invention, the supervisor or decision-maker is able to review the travel history of the user submitting request. The supervisor can be presented with a list of the travel requests that had been approved and taken by a user over a predetermined time period. The supervisor can also access cost information relating to the amount of money that has been on traveling by users. The cost information can be organized into several different categories for the convenience of the supervisor.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for managing travel expenses of an organization, the system comprising:
a server computer comprising a processor and a storage device;
a client computer connected to the server computer; and
an application for managing travel expenses stored in the storage device of the server computer and accessible by a user on the client computer, the application comprising:
means for submitting a travel request for a trip by a user;
means for evaluating a travel request by a supervisor of a user;
means for scheduling a conference call;
means for collaborating online; and
means for assisting a user submit an expense report.

2. The system of claim 1 further comprising means for providing a user with a list of travel requests submitted by a user, the list of travel requests includes information on the status of each travel request in the list of travel requests and description information on each travel request in the list of travel requests.

3. The system of claim 1 wherein the means for submitting a travel request further comprises:
means for entering personal information about a user;
means for entering flight information about the trip;
means for entering business reasons for the trip;
means for entering travel justification reasons; and
means for notifying a supervisor of the submission of a travel request by a user.

4. The system of claim 3 wherein:
the personal information includes a name, a telephone number, a fax number, a manager, an organizational division, and a travel identifier;
the flight information includes a departure airport, a departure date, a departure time, a destination airport, a return date, a return time and a cost for the flight;
the means for entering business reasons for the trip comprise:
means for entering a trip classification; and
means for entering a trip purpose; and
the means for entering travel justification reasons comprises means for discussing travel alternatives, wherein the travel alternatives include at least one of conference call, video conference and online collaboration.

5. The system of claim 4 wherein the means for entering flight information comprises means for entering multiple destination airports for the trip.

6. The system of claim 1 wherein the means for evaluating a travel request by a supervisor of a user further comprises:
means for displaying a list of pending travel requests submitted by users;
means for obtaining additional information on a pending travel request from the list of pending travel requests;
means for indicating a supervisor's evaluation of a pending travel request; and
means for notifying users of a supervisor's evaluation of a pending travel request.

7. The system of claim 6 wherein the means for indicating a supervisor's evaluation of a pending travel request comprises means for selecting, by a supervisor, one of approved, rejected, pending or forwarded.

8. The system of claim 1 wherein the means for scheduling a conference call further comprises:
means for entering call information;
means for entering participant information on each participant; and
means for notifying each participant included in the participant information of the conference call.

9. The system of claim 8 wherein:
the call information includes a date, a time, a duration and a subject; and
the participant information includes an e-mail address of the participant.

10. The system of claim 1 wherein:
the client computer and the server computer are connected over an Intranet; and
the application is a module for an Intranet portal to access the Intranet.

11. A computer program product embodied on a computer readable medium and executable by a computer for managing travel expenses of an organization, the computer program product comprising:
means for submitting a travel request for a trip by a user;
means for evaluating a travel request by a supervisor of a user;
means for scheduling a conference call;
means for collaborating online; and
means for providing a user with a list of travel requests submitted by a user.

12. The computer program product of claim 11 wherein:
the means for providing a user with a list of travel requests submitted by a user comprises:
means for removing a travel request from the list of travel requests submitted by a user; and
means for obtaining additional information on a travel request in the list of travel requests submitted by a user; and
the list of travel requests includes information on the status of each travel request in the list of travel requests submitted by a user and description information on each travel request in the list of travel requests submitted by a user.

13. The computer program product of claim 11 wherein the means for submitting a travel request further comprises:
means for entering personal information about a user;
means for entering flight information about the trip;
means for entering business reasons for the trip;
means for entering travel justification reasons; and
means for notifying a supervisor of the submission of a travel request by a user.

14. The computer program product of claim 13 wherein:
the personal information includes a name, a telephone number, a fax number, a manager, an organizational division, and a travel identifier; the flight information includes a departure airport, a departure date, a departure time, a destination airport, a return date, a return time and a cost for the flight;
the means for entering business reasons for the trip comprise:
means for entering a trip classification; and
means for entering a trip purpose; and
the means for entering travel justification reasons comprises means for discussing travel alternatives, wherein the travel alternatives include at least one of conference call, video conference and online collaboration.

15. The computer program product of claim 14 wherein the means for entering flight information comprises means for entering multiple destination airports for the trip.

16. The computer program product of claim 11 wherein the means for evaluating a travel request by a supervisor of a user further comprises:
means for displaying a list of pending travel requests submitted by users;
means for obtaining additional information on a pending travel request from the list of pending travel requests;
means for indicating a supervisor's evaluation of a pending travel request; and
means for notifying users of a supervisor's evaluation of a pending travel request.

17. The computer program product of claim 16 wherein the means for indicating a supervisor's evaluation of a pending travel request comprises means for selecting, by a supervisor, one of approved, rejected, pending or forwarded.

18. The computer program product of claim 11 wherein the means for scheduling a conference call further comprises:
means for entering call information;
means for entering participant information on each participant; and
means for notifying each participant included in the participant information of the conference call.

19. The computer program product of claim 18 wherein:
the call information includes a date, a time, a duration and a subject; and
the participant information includes an e-mail address of the participant.

20. The computer program product of claim 11 further comprising:
means for a user to obtain additional travel services; and
means for assisting a user submit an expense report.
